(19) United States
(12) Patent Application Publication
(10) Pub. No.: US 2012/0018010 A1
(43) Pub. Date: Jan. 26, 2012

(54) Hydraulic Transmission

(75) Inventors: Michael Gaumnitz, Horb (DE); Rupert Kinzler, Ludwigsburg (DE)

(73) Assignee: Robert Bosch GmbH, Stuttgart (DE)

(21) Appl. No.: 13/185,726

(22) Filed: Jul. 19, 2011

(30) Foreign Application Priority Data
Jul. 21, 2010 (DE) 10 2010 031 817.5

(51) Int. Cl. F16K 31/12

(52) U.S. Cl. 137/485

(57) ABSTRACT

A hydraulic transmission has a primary unit and a secondary unit, which are connected to each other in a closed circuit by way of a first and a second working line. The primary unit and/or the secondary unit has a plurality of cylinder/piston units, which can each be activated or deactivated by means of a first valve and a second valve. This serves the purpose of setting a time-averaged volume flow of the unit. In this arrangement, both valves of each cylinder/piston unit are designed as high-pressure valves. A reversal in the direction of rotation, e.g. a reversal in the direction of travel, and a change from drive to overrun, during regenerative braking for example, is accomplished within the closed circuit of the transmission without a reversal in the direction of delivery by means of a changeover between low pressure and high pressure.

This application claims priority under 35 U.S.C. §119 to German patent application no. DE 10 2010 031 817.5, filed Jul. 21, 2010 in Germany, the disclosure of which is incorporated herein by reference in its entirety.

### BACKGROUND

The disclosure relates to a hydraulic transmission having a positive displacement machine.

In hydraulic transmissions having a conventional positive displacement pump and a conventional positive displacement motor, which can be embodied as radial-piston or as axial-piston machines for example, control of the inlet flow and the outlet flow and control of the connections to the high pressure and to the low pressure of the individual cylinder/piston units are accomplished mechanically. In the case of an axial-piston pump, for example, two kidney-shaped ports are used, by means of which the connections to the high-pressure side and to the low-pressure side are opened during a certain region of the circular path and hence during a certain portion of the stroke of the cylinder/piston units. In the case of radial-piston pumps, a mechanical high-pressure valve and a mechanical low-pressure valve are provided for each unit. The high-pressure valves always open when a certain pressure in the respective cylinder is exceeded, thus allowing the pressure medium at elevated pressure to flow off to the high-pressure side of the pump.

The disadvantage with hydrostatic transmissions having such positive displacement machines is that all the cylinder/piston units are active at all times.

Printed publication WO 2008/012577 A2 discloses a hydraulic transmission having two valve-controlled positive displacement machines, which are connected to each other by way of an open circuit.

In such valve-controlled positive displacement machines, each cylinder/piston unit is assigned an electrically actuated low-pressure valve and an electrically actuated high-pressure valve. The cylinder/piston units can thus be controlled separately in pump mode, motor mode and what is referred to as an “idle mode”. The idle mode allows individual units to be deactivated or switched to a force-free state through continuous opening of the low-pressure valve thereof and continuous closure of the high-pressure valve thereof. In this way, the volume flow or rotational speed of the positive displacement machine can be reduced. In partial mode, the volume available or the working stroke of the unit concerned is only partially used, while the other part is switched to a substantially force-free state by opening the low-pressure valve.

The disadvantage with hydraulic transmissions of this kind, which are used as travel drives for example, is that in the case of a change from drive to overrun, during regenerative braking for example, there has to be a reversal of the flow in the high-pressure line of the open circuit. In this case, there are difficulties in controlling the restarting of the valve-controlled positive displacement machine which is being switched from pump mode to motor mode.

Printed publication WO 2008/012558 A2 discloses a hydraulic transmission having two valve-controlled positive displacement machines, which are connected by way of two working lines to form a closed circuit.

The disadvantage with hydraulic transmissions of this kind is that a reversal in the direction of rotation is provided only while retaining a predetermined high-pressure line. In this case, the abovementioned difficulties with switching over and/or restarting the valve-controlled positive displacement machine operated as a motor persist.

Given this situation, it is the underlying object of the disclosure to provide a hydraulic transmission having at least one valve-controlled positive displacement machine or digital variable radial-piston machine (DVR), the direction of rotation of which can be reversed in a simple and reliable manner.

This object is achieved by a hydraulic transmission in accordance with the present disclosure.

### SUMMARY

The hydraulic transmission according to the disclosure has a primary unit and a secondary unit, which are connected to each other in a closed circuit by way of a first and a second working line. The primary unit and/or the secondary unit is designed as a DVR having a plurality of cylinder/piston units, which can each be activated or deactivated by means of a first valve and a second valve. This serves the purpose of setting a time-averaged volume flow of the primary and/or secondary unit. In this arrangement, both valves of each cylinder/piston unit are designed as high-pressure valves. A reversal in the direction of rotation, e.g. a reversal in the direction of travel, and a change from drive to overrun, during regenerative braking for example, is accomplished within the closed circuit of the transmission according to the disclosure without a reversal in the direction of delivery by means of a changeover between low pressure and high pressure. Both valves are suitable for this purpose by virtue of the fact that they are designed as high-pressure valves. This gives a hydraulic transmission having a valve-controlled positive displacement machine (DVR), the direction of rotation of which can be reversed in a simple and reliable manner.

Further advantageous embodiments of the disclosure are described below.

In a particularly preferred development, both working lines are designed as high-pressure lines. A reversal in the direction of rotation and a change from drive to overrun is accomplished by means of a changeover between low pressure and high pressure. Both working lines are suitable for this purpose by virtue of the fact that they are designed as high-pressure lines.

In a particularly preferred development, the first and the second valve of each cylinder/piston unit are identical. These identical parts reduce the number of parts in the transmission according to the disclosure.

In a particularly preferred variant embodiment, in which the valves have a high leaktightness and the closing bodies thereof have short strokes, both valves are seat valves with hydraulic pilot control.

It is preferred here if both valves have a differential cylinder, the actuating piston of which is connected to a closing body of the valve. In this case, the actuating piston has a head space, which can be subjected to pressure in the closing direction of the valve, and an annular space, which can be subjected to pressure in the opening direction of the valve.

In a preferred illustrative embodiment, the head space of the first valve and the annular space of the second valve are hydraulically coupled, while the annular space of the first valve and the head space of the second valve are likewise hydraulically coupled. This ensures simultaneous and alternate actuation of the two valves.

It is preferred here if the head space of the first valve and the annular space of the second valve can be connected to the first or second working line by way of a first common connecting line and by way of a first directional control valve, while the annular space of the first valve and the head space of the second valve can be connected to the second or the first working line by way of a second common connecting line and by way of a second directional control valve.

In another preferred illustrative embodiment, the head space and the annular space of the first valve are connected to a first directional control valve, while the head space and the annular space of the second valve are connected to a second directional control valve.

It is preferred here if either the head space of the first valve is connected to the first working line, and the annular space of the first valve is connected to the second working line, or the head space of the first valve is connected to the second working line, and the annular space of the first valve is connected to the first working line, by way of the first directional control valve.

It is furthermore preferred here if either the head space of the second valve is connected to the second working line, and the annular space of the second valve is connected to the first working line, or the head space of the second valve is connected to the first working line, and the annular space of the second valve is connected to the second working line, by way of the second directional control valve.

In a particularly preferred variant embodiment, the first and the second valve are slide valves having a valve slide which can be moved by an actuator against the force of a spring acting on the valve slide. In this case, operating surfaces acted upon in the direction of movement of the valve slide are partially or completely pressure-force-compensated. As a result, only small operating forces are required, thereby allowing rapid operation of the valves.

The actuator can be a differential cylinder.

It is preferred here if a head space and an annular space of each differential cylinder are connected alternately to the two working lines by way of respective 4/2-way valves.

The actuator can be a solenoid.

It is preferred here if the respective valve housings of the first and second valves have a valve bore containing two pressure spaces spaced apart in the direction of movement, one of which is connected to the respective working line and the other is connected to the cylinder of the respective cylinder/piston unit. In this case, a connection between the pressure spaces can be controlled by means of a radially stepped-back region of the valve slide, said region being bounded by two annular operating surfaces, which are arranged substantially perpendicularly to the direction of movement and are of substantially the same size. As a result, the two operating surfaces are either acted upon jointly by the pressure in one pressure space or by the pressure in the other pressure space or are acted upon by the pressure in the two connected pressure spaces, and are therefore force-balanced, especially under high pressure.

To protect the cylinder/piston units against impermissibly high pressures, it is preferred if the cylinders thereof are connected by way of relief lines to shuttle valves, which are connected by way of respective branch lines to the two working lines. In this case, a pressure-limiting valve formed by a nonreturn valve preloaded in the closing direction by a spring is provided in the relief lines.

In a particularly preferred variant embodiment, both valves are seat-and-slide valves having a valve slide, with operating surfaces acted upon in directions of movement of the valve slide being partially or completely pressure-force-compensated. These valves have a short stroke, require low operating forces and offer high leaktightness.

It is preferred if the secondary unit is a bent-axis or swash plate unit. This can be adjustable.

### BRIEF DESCRIPTION OF THE DRAWINGS

Various illustrative embodiments of the disclosure will be described in detail below with reference to the figures, of which:

FIG. 1 shows a circuit diagram of a hydraulic transmission according to the disclosure in accordance with a first illustrative embodiment;

FIG. 2 shows a circuit diagram of a cylinder/piston unit of a valve-controlled positive displacement machine of a hydraulic transmission according to the disclosure having two hydraulically pilot-controlled seat valves in accordance with a first variant;

FIG. 3 shows a circuit diagram having two hydraulically pilot-controlled seat valves in accordance with a second variant;

FIG. 4 shows a circuit diagram of a cylinder/piston unit of a valve-controlled positive displacement machine of a hydraulic transmission according to the disclosure having two slide valves in accordance with a third variant; and

FIG. 5 shows a circuit diagram having two slide valves in accordance with a fourth variant.

### DETAILED DESCRIPTION

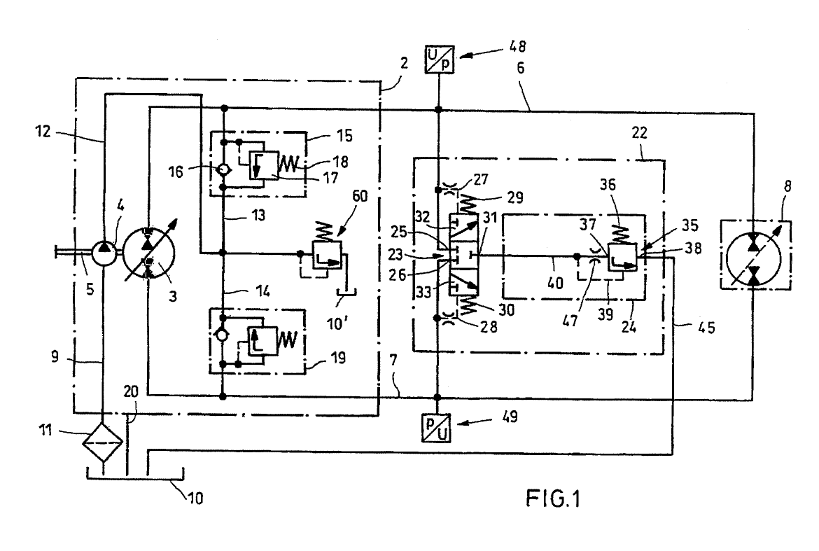

FIG. 1 shows a circuit diagram of a hydraulic transmission according to the disclosure in accordance with a first illustrative embodiment.

A hydraulic circuit comprises a unit 2 having a valve-controlled primary unit 3 (DVR) and having an auxiliary pump 4, the auxiliary pump 4 and the primary unit 3 being driven jointly by way of a shaft 5 in a first operating state, which is described below. The shaft 5 is connected to a driving machine, which is not shown in FIG. 1. For the first operating state, the primary unit 3 is designed to deliver pressure medium in two directions, and the delivery volume thereof can be adjusted by way of a full mode, a partial mode and an idle mode of the cylinder/piston units thereof. A first working line 6 and a second working line 7 are connected to the primary unit 3, and therefore, when pressure medium is delivered into the first working line 6, the first working line 6 becomes the high-pressure side and the second working line 7 becomes the low-pressure side of the hydraulic circuit.

The pressure medium delivered into the first working line 6 by the primary unit 3, for example, drives a secondary unit 8 (DVR), which is likewise valve-controlled in this illustrative embodiment. The displacement of the secondary unit 8 can accordingly likewise be varied by way of a full mode, a partial mode and an idle mode of the cylinder/piston units thereof.

The auxiliary pump 4 is used to fill the hydraulic circuit with a pressure medium. For this purpose, the auxiliary pump 4 draws in pressure medium from a tank 10 via a suction line 9. A filter 11 is preferably arranged at the tank end of the suction line 9 to filter out dirt particles from the pressure medium drawn in and hence to protect the hydraulic circuit and, above all, the sensitive components arranged therein, such as valves, from contamination.

The auxiliary pump 4 delivers the pressure medium drawn in into a feed duct 12, which is connected to the first working line 6 by way of a first feed duct section 13. The second working line 7 is connected to the feed duct 12 by way of a second feed duct section 14. Arranged in the first feed duct section 13 is a feed valve unit 15, which comprises a nonreturn valve 16 opening in the direction of the first working line 6. If the pressure in the first working line 6 falls below the pressure level in the feed duct 12, the nonreturn valve 16 opens and the pressure medium delivered by the auxiliary pump 4 is fed to the first working line 6. A pressure-limiting valve 17 is provided in the feed valve unit 15, in parallel with the nonreturn valve 16, said pressure-limiting valve producing a connection of the first feed duct section 13 through which fluid can flow in the closing direction of the nonreturn valve 16 if a limiting value for the working line pressure in the first working line 6, which is defined by a spring 18, is exceeded.

Arranged in the second feed duct section 14 is a second feed valve unit 19, the construction of which corresponds to that of the first feed valve unit 15, the nonreturn valve arranged in the second feed valve unit 19 opening in the direction of the second working line 7, and the pressure-limiting valve once again producing a connection through which fluid can flow in the closing direction of the nonreturn valve.

The two feed valve units 15 and 19 ensure that the working line 6 or 7 in which the working line pressure falls below the pressure level in the feed duct 12 is connected to the feed duct 12. At the same time, this ensures that a critical pressure rise in the working line 6 or 7 carrying the high pressure is relieved in the direction of the low-pressure side since the pressure-limiting valve on the high-pressure side opens and, by virtue of the connection thus produced, the nonreturn valve of the other feed valve unit in each case likewise opens. Short-circuiting the first working line 6 and the second working line 7 in this way prevents pressure peaks that could damage the unit 2 or the lines connected thereto. To avoid an excessive pressure in the feed duct 12, a pressure-limiting valve 60 is furthermore provided, said valve connecting the feed duct 12 to an internal tank volume 10′ if a critical pressure is exceeded. The internal tank volume 10′ also receives the leakage fluid from the primary unit 3 and the auxiliary pump 4.

Unit 2 is connected to the tank 10 by way of a leakage line 20, the leakage fluid which arises in unit 2 initially being collected in the housing of unit 2 and flowing off in the direction of the tank 10 when a certain leakage quantity is reached. The secondary unit 8 is connected to the tank 10 in corresponding fashion by way of a leakage line 21.

A purging device 22 is furthermore arranged in the hydraulic circuit. It is the function of the purging device 22 to remove a defined quantity of pressure medium from the first working line 6 or the second working line 7, provided the pressure in the working line 6 or 7 from which the pressure medium is removed is within a certain pressure range. For this purpose, the purging device 22 comprises a connecting valve 23 and a purge valve unit 24, which is connected downstream of the connecting valve 23.

The connecting valve 23 has a first inlet port 25 and a second inlet port 26. The first inlet port 25 is connected to the first working line 6 by way of a connecting duct. The second inlet port 26 is connected in a corresponding fashion to the second working line 7 by way of a further connecting duct. In the illustrative embodiment depicted, the connecting valve 23 is embodied as a 3/3-way valve, being subjected to the pressure in the first working line 6 via a first measuring line 27 and, in the opposite direction, to the pressure in the second working line 7 via a second measuring line 28, to deflect it out of its rest position. The first measuring line 27 and the second measuring line 28 each have a restriction. If the pressures acting on the measuring surfaces connected to the first measuring line 27 and the second measuring line 28, respectively, are approximately equal, the connecting valve 23 is moved into its rest position by means of a first centering spring 29 and a second centering spring 30.

In the rest position of the connecting valve 23, the first inlet port 25, the second inlet port 26 and an outlet port 31 are separated from one another. If, on the other hand, the measuring surface connected to the first measuring line 27 is subjected to a higher pressure, for example, than the oppositely oriented measuring surface, which is connected to the second working line 7 via the second measuring line 28, owing to a pressure difference between the first working line 6 and the second working line 7, the connecting valve 23 is deflected in the direction of a first end position 32. In the first end position 32, the second inlet port 26 is connected to the outlet port 31 via the connecting valve 23. Conversely, if the pressure in the second working line 7 exceeds that in the first working line 6, the connecting valve 23 is deflected in the direction of its second end position 33, in which the first inlet port 25 is connected to the outlet port 31. This means that the inlet port 25 or 26 connected to the outlet port 31 is the one subject to the pressure in the working line 6 or 7 which is lower than the other working line 7 or 6.

On the inlet side, the purge valve unit 24 is connected to the outlet port 31 of the connecting valve 23 by way of a connecting duct 40. In the first illustrative embodiment depicted, the purge valve unit 24 is designed as a purge pressure holding valve 35. The purge pressure holding valve 35 is held by the force of a compression spring 36 in its initial position, in which the connection between an inlet of the purge pressure holding valve 35 and an outlet of the purge pressure holding valve 35 is interrupted.

A hydraulic force is produced at a measuring surface of the purge pressure holding valve 35, counter to the force of the compression spring 36, the measuring surface being connected to the connecting duct 40 by way of a third measuring line 39. If the hydraulic force acting on the measuring surface of the purge pressure holding valve 35 exceeds the force of the compression spring 36 acting in the opposite direction, an inlet 37 of the purge pressure holding valve 35 is connected to the outlet of the purge pressure holding valve 38. A pressure threshold is thus defined by means of the compression spring 36.

If the lower of the pressures prevailing in the first working line 6 and the second working line 7 is within this range, pressure medium is removed from the corresponding working line 6 or 7 via the connecting valve 23 and the downstream purge valve unit 24. This pressure medium which has been removed flows into the tank 10 via a tank line 45. In order to remove a defined purge oil quantity from the hydraulic circuit, a restriction 47 is provided, said restriction being arranged in the connecting duct 40 in the illustrative embodiment depicted. In this arrangement, the restrictor is downstream of the point at which the measuring line 39 is connected to the connecting duct 40. It is also possible to arrange the restriction 47 downstream of the purge pressure holding valve 35.

The pressure medium delivered into the tank volume via the tank connection line 45 is cooled and is then drawn in by the auxiliary pump 4 via the filter 11 and the suction line 9 and fed back to the hydraulic circuit.

The hydraulic transmission according to the disclosure in accordance with FIG. 1 can also be operated in such a way that the secondary unit 8 is operated as a motor and the primary unit 3 is operated as a pump. In both operating modes, the directions of rotation of the units 3, 8 can be either of the conceivable directions. The two working lines 6, 7 can both be operated as high-pressure and low-pressure lines.

A pressure sensor 48, 49 is arranged on each of the two working lines 6, 7. These serve to determine the high-pressure and the low-pressure side of the hydraulic transmission according to the disclosure in the various possible operating states thereof. A correct switchover of the cylinder/piston units (cf. following figures) of the two machines 3, 8 between full, partial and idle mode in pump and motor operation is thus possible.

The hydraulic transmission can be used as a travel drive, the primary unit 3 being driven by an internal combustion engine (not shown) by way of the shaft 5 and being used as a pump in the travel mode of the transmission.

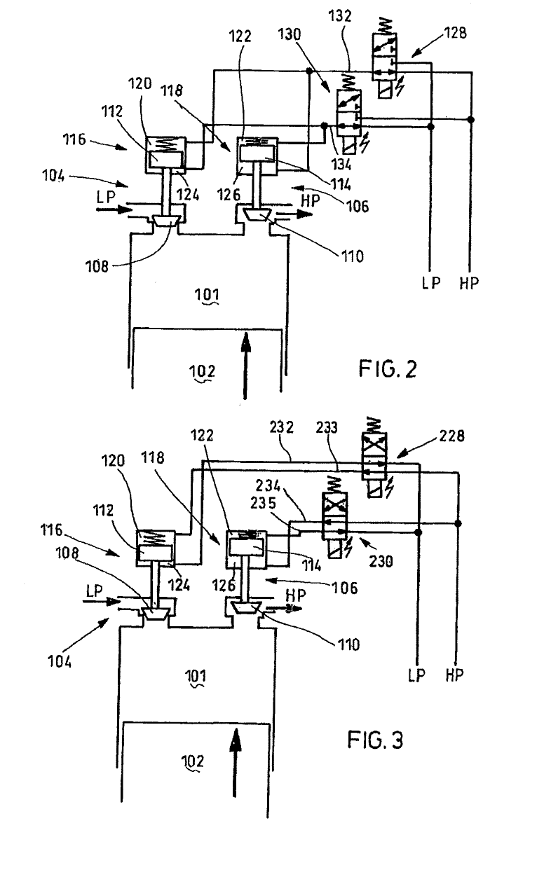

FIG. 2 shows a first variant of a circuit diagram of a cylinder/piston unit 101, 102 of a primary unit 3 and/or of a secondary unit 8, which is used as in a hydraulic transmission in accordance with FIG. 1.

The primary unit 3 and/or the secondary unit 8 can be a radial-piston machine, in which six cylinder/piston units 101, 102, for example, are arranged in a star shape. In this case, the machine 3, 8 accordingly has the arrangement shown in FIG. 2 six times over.

Each cylinder 101 has a first working port, which is controlled by a first hydraulically pilot-controlled seat valve 104. Each cylinder 101 furthermore has a second working port, which is controlled by a second hydraulically pilot-controlled seat valve 106. In a predetermined delivery direction in the hydraulic transmission, the second working port is assumed to be the outlet port or high-pressure port HP, while the first working port is assumed to be the inlet port or low-pressure port LP. The two seat valves 104, 106 are of identical construction. They have an approximately frustoconical closing body 108, 110, which is pressed into a corresponding valve seat against the pressure prevailing in the cylinder 101 by means of an actuating piston 112, 114 in order to close the corresponding working port LP, HP.

The actuating piston 112, 114 is guided in a differential cylinder 116, 118, a pressure in the head space 120, 122 of the latter acting in the closing direction of the corresponding seat valve 104, 106, while a pressure in the annular space 124, 126 thereof acts in the opening direction of the seat valve 104, 106. A spring, which is supported on the differential cylinder 116, 118 and preloads the closing body 108, 110 in the closing direction of the seat valve 104, 106 by way of the actuating piston 112, 114, is furthermore provided in the head space 120, 122.

A surface of the actuating piston 112, 114, said surface acting in the closing direction and being arranged in the head space 120, 122, is somewhat larger than an effective sealing surface of the closing body 108, 110. This provides a safety function, which ensures that the seat valve 104, 106 opens if the pressure in the cylinder 101 is impermissibly high. At the same time, the effective surface of the actuating piston 112, 114 in the closing direction is large enough to ensure reliable sealing of the seat valves 104, 106.

A first 3/2-way valve 128 and a second 3/2-way valve 130 are provided for the purpose of controlling the seat valves 104, 106. The first 3/2-way valve 128 alternately connects one of the two working ports LP, HP of the valve-controlled positive displacement machine to a first connecting line 132, while the second 3/2-way valve 130 alternately connects one of the two working ports LP, HP to a second connecting line 134. The first connecting line 132 branches to the head space 120 of the first differential cylinder 116, on the one hand, and to the annular space 126 of the second differential cylinder 118, on the other hand, while the second connecting line 134 branches to the annular space 124 of the first differential cylinder 116, on the one hand, and to the head space 122 of the second differential cylinder 118, on the other hand.

FIG. 2 shows the two 3/2 way valves 128, 130 in their respective energized operating positions, in which a valve body (not shown) has been moved against the force of a spring. In this case, the head space 120 of the first differential cylinder 116 and the annular space 126 of the second differential cylinder 118 are connected to the high-pressure port HP of the positive displacement machine, with the result that the first seat valve 104 is closed while the second seat valve 106 is open. Since (according to the arrow) in FIG. 2, the piston 102 performs a displacement stroke in the cylinder 101, the open second working port of the cylinder 101 is the high-pressure port HP, while the first, closed working port is the low-pressure port LP.

During an intake stroke of the piston 102, which follows the operating state shown in FIG. 2, both 3/2-way valves 128, 130 are deenergized, with the result that the first seat valve 104 opens, while the second seat valve 106 closes. The cylinder/piston unit 101, 102 is thus accordingly connected to low pressure LP.

FIG. 3 shows a circuit diagram of the cylinder/piston unit 101, 102 having the two hydraulically pilot-controlled seat valves 104, 106 in accordance with FIG. 2, with the pilot control valves and the connection thereof to the differential cylinders 116, 118 having been modified in this second variant. Instead of the two 3/2-way valves 128, 130, a first 4/2-way valve 228 and a second 4/2-way valve 230 are provided. These are each connected to the high-pressure port HP and the low-pressure port LP of the positive displacement machine (in the same way as in the first variant). According to the second variant, the first 4/2-way valve 228 is connected to the two pressure spaces 120, 124 of the first differential cylinder 116 by way of two separate connecting lines 232, 233, while the second 4/2-way valve 230 is connected to the two pressure spaces 122, 126 of the second differential cylinder 118 by way of two separate connecting lines 234, 235. The first 4/2-way valve 228 is thus unambiguously associated with the first working port LP and the second 4/2-way valve 230 is unambiguously associated with the second working port HP of the cylinder/piston unit 101, 102. By means of the respective energized operating positions of the 4/2-way valves 228, 230 illustrated in FIG. 3, the head space 120 of the first differential cylinder 116 is subjected to high pressure, with the result that the first seat valve 104 is closed, while the annular space 126 of the second differential cylinder 118 is subjected to high pressure, with the result that the second seat valve 106 is opened. “In parallel” therewith, the annular space 124 of the first differential cylinder 116 and the head space 122 of the second differential cylinder 118 are connected by way of the respective directional control valve 228, 230 to the low-pressure port LP of the positive displacement machine. Thus FIG. 3 shows the same operating state of the cylinder/piston unit 101, 102 as in FIG. 2, in which the piston 102 is executing a displacement stroke.

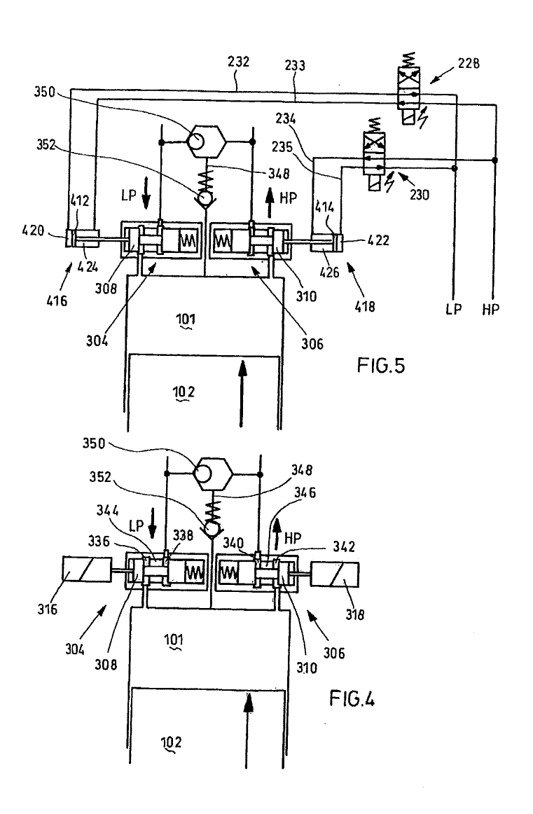

FIG. 4 shows a circuit diagram of the cylinder/piston unit 101, 102 of a primary unit 3 and/or a secondary unit 8 of a hydraulic transmission according to the disclosure in accordance with FIG. 1. Here, two slide valves 304, 306 of identical construction are provided for controlling the two working ports LP, HP of the cylinder 101. Each slide valve 304, 306 has a valve housing, in which a valve bore is provided. Two mutually spaced pressure spaces 336, 338 and 340, 342, respectively, are formed on the outer circumference of the valve bore by radial widening of the valve bore. The pressure space 336 of the first slide valve 304 and the pressure space 342 of the second slide valve 306 are connected to the cylinder 101. The pressure space 338 of the first slide valve 304 is connected to the low-pressure port LP of the positive displacement machine, while the pressure space 340 of the second slide valve 306 is connected to the high-pressure port HP of the positive displacement machine.

Respective valve slides 208, 310 are guided movably in the valve housing for the purpose of controlling the respective pressure medium connections between the pressure spaces 336, 338 and 340, 342. The valve slide 208, 310 has a radially stepped-back region 344, 346, it being possible for pressure medium to flow via the radially stepped-back region 344 of the first slide valve 304 from the low-pressure port LP of the positive displacement machine to the cylinder 101, while it is possible for pressure medium to flow via the radially stepped-back region 346 of the second slide valve 306 from the cylinder 101 to the high-pressure port HP of the positive displacement machine. For this purpose, the respective valve slide 208, 310 is set to the home position, subject to preload by a respective spring, which is shown in FIG. 4. A solenoid 316, 318, by means of which the slide valve 304, 306 can be closed when energized, is arranged on the valve slide 208, 310.

During the displacement stroke of the piston 102, which is shown in FIG. 4 and during which said piston moves outwards (in FIG. 4), the first solenoid 316 is activated or energized, with the result that the valve slide 208 is moved to the right (in FIG. 4) against the force of the spring, and the first slide valve 304 thus closes.

To protect the cylinder/piston unit 101, 102 against impermissibly high pressures, a relief line 348 and a shuttle valve 350, by means of which the working port (the right-hand working port in FIG. 4) under high pressure in the respective operating state of the positive displacement machine is connected to the relief line 348, are provided on the cylinder 101. Provided in the relief line 348 is a pressure-limiting valve, which is formed by a nonreturn valve 352 preloaded by a spring. This valve opens when the pressure in the cylinder 101 rises above that at the high-pressure working port of the positive displacement machine plus the equivalent of the spring force.

FIG. 5 shows a fourth variant of a circuit diagram with a cylinder/piston unit 101, 102 and with two slide valves 304, 306 of identical construction and with a pressure-limiting circuit 348, 350, 352 in accordance with the third variant described above. As a departure from the third variant, the actuation of the valve slides 208, 210 is here accomplished by means of respective differential cylinders 416, 418, which are of smaller design than the differential cylinders 116, 118 of the first two variants owing to the pressure-balanced embodiment of the valve slide 308, 210. Each differential cylinder 416, 418 has an actuating piston 412, 414 connected to the valve slide 308, 210 and separating a head space 420, 422 from an annular space 424, 426. Here, the pressure in the head space 420, 422 acts in the closing direction, and the pressure in the annular space 424, 426 acts in the opening direction of the slide valve 304, 306.

The pressurization of the two pressure spaces 422, 426 of the second differential cylinder 418 is accomplished by means of the second 4/2-way valve 230 in the same way as described with reference to FIG. 3. The pressurization of the two pressure spaces 420, 424 of the first differential cylinder 416 by means of the first 4/2-way valve 228 is performed in the opposite way to that in the variant shown in FIG. 3: in the energized operating position thereof (illustrated in FIG. 5), the first 4/2-way valve 228 connects the high-pressure port HP of the positive displacement machine to the annular space 424 of the first differential cylinder 416, with the result that the first slide valve 304 is open. “In parallel”, the low-pressure port LP of the positive displacement machine is in this case connected to the head space 420 of the first differential cylinder 416. In the home position thereof, subject to preload by a spring, the connections are “diagonally” interchanged, with the result that the high-pressure port HP of the positive displacement machine is connected to the head space 420 and the first slide valve 304 closes.

The disclosure is of a hydraulic transmission having a primary unit and having a secondary unit, which are connected to each other in a closed circuit by way of a first and a second working line. The primary unit and/or the secondary unit has a plurality of cylinder/piston units, which can each be activated or deactivated by means of a first valve and a second valve. This serves the purpose of setting a time-averaged volume flow of the unit. In this arrangement, both valves of each cylinder/piston unit are designed as high-pressure valves. A reversal in the direction of rotation, e.g. a reversal in the direction of travel, and a change from drive to overrun, during regenerative braking for example, is accomplished within the closed circuit of the transmission according to the disclosure without a reversal in the direction of delivery by means of a changeover between low pressure and high pressure.

What is claimed is:

1. A hydraulic transmission having a primary unit and a secondary unit which are connected to each other in a closed circuit by way of a first and a second working line, wherein the primary unit and/or the secondary unit has a plurality of cylinder/piston units which can each be activated or deactivated by way of a first valve and a second valve so as to set a volume flow of the primary unit and/or secondary unit, wherein both valves are configured as high-pressure valves.

2. The hydraulic transmission according to claim 1, wherein the first working line and the second working line are configured as high-pressure lines.

3. The hydraulic transmission according to claim 1, wherein the first valve and the second valve of each cylinder/piston unit are of identical construction.

4. The hydraulic transmission according to claim 1, wherein the first valve and the second valve are seat valves with hydraulic pilot control.

5. The hydraulic transmission according to claim 4, wherein the first valve and the second valve each have a differential cylinder, the actuating piston of which is connected to a closing body of the valve, and wherein the actuating piston has a head space which is configured to be subjected to pressure in the closing direction of the valve, and an annular space which is configured to be subjected to pressure in the opening direction of the valve.

6. The hydraulic transmission according to claim 5, wherein the head space of the first valve and the annular space of the second valve are hydraulically coupled, and wherein the annular space of the first valve and the head space of the second valve are hydraulically coupled.

7. The hydraulic transmission according to claim 6, wherein the head space of the first valve and the annular space of the second valve are configured to be connected to the first or second working line by way of a first connecting line and by way of a first directional control valve, and wherein the annular space of the first valve and the head space of the second valve are configured to be connected to the second or the first working line by way of a second connecting line and by way of a second directional control valve.

8. The hydraulic transmission according to claim 5, wherein the head space and the annular space of the first valve are connected to a first directional control valve, and wherein the head space and the annular space of the second valve are connected to a second directional control valve.

9. The hydraulic transmission according to claim 8, wherein either the head space of the first valve is connected to the first working line, and the annular space of the first valve is connected to the second working line, or the head space of the first valve is connected to the second working line, and the annular space of the first valve is connected to the first working line, by way of the first directional control valve.

10. The hydraulic transmission according to claim 8, wherein either the head space of the second valve is connected to the second working line, and the annular space of the second valve is connected to the first working line, or the head space of the second valve is connected to the first working line, and the annular space of the second valve is connected to the second working line, by way of the second directional control valve.

11. The hydraulic transmission according to claim 1, wherein the first valve and the second valve are slide valves having a valve slide which is configured to be moved by an actuator against the force of a spring acting on the valve slide, and wherein operating surfaces acted upon in the direction of movement of the valve slide are partially or completely pressure-force-compensated.

12. The hydraulic transmission according to claim 11, wherein the actuator is a differential cylinder.

13. The hydraulic transmission according to claim 12, wherein a head space and an annular space of each differential cylinder are connected alternately to the two working lines by way of respective 4/2-way valves.

14. The hydraulic transmission according to claim 11, wherein the actuator is a solenoid.

15. The hydraulic transmission according to claim 11, wherein the respective valve housings of the first and second valves have a valve bore containing two pressure spaces spaced apart in the direction of movement, one of which is connected to the respective working line and the other is connected to the cylinder of the respective cylinder/piston unit, and wherein a connection between the pressure spaces can be controlled by means of a radially stepped-back region of the valve slide, said region being bounded by two annular operating surfaces, which are arranged substantially perpendicularly to the direction of movement and are of substantially the same size.

16. The hydraulic transmission according to claim 11, wherein the cylinders of the cylinder/piston units are connected by way of respective relief lines to respective shuttle valves, which are connected by way of branch lines to the two working lines, and wherein a pressure-limiting valve formed by a nonreturn valve preloaded in the closing direction by a spring is provided in the relief lines.

17. The hydraulic transmission according to claim 1, wherein the first valve and the second valve are seat-and-slide valves having a valve slide, and wherein operating surfaces acted upon in directions of movement of the valve slide are partially or completely pressure-force-compensated.

18. The hydraulic transmission according to claim 1, wherein the secondary unit is a bent-axis or swash plate unit.
